(19) United States
(12) Patent Application Publication
(10) Pub. No.: US 2013/0299294 A1
(43) Pub. Date: Nov. 14, 2013

(54) FREEWHEEL CAGE

(71) Applicant: Schaeffler Technologies AG & Co. KG, Herzogenaurach (DE)

(72) Inventors: Swen Doerrie, Herzogenaurach (DE); Birgit Spies, Buch (DE); Frieder Altmann, Pommersfelden (DE); Franz-Josef Vossebuerger, Nuernberg (DE)

(73) Assignee: Schaeffler Technologies AG & Co., KG, Herzogenaurach (DE)

(21) Appl. No.: 13/893,843

(22) Filed: May 14, 2013

(30) Foreign Application Priority Data
May 14, 2012 (DE) 102012208057.0

(51) Int. Cl. F16D 41/00

(52) U.S. Cl. CPC F16D 41/00
USPC 192/45.001; 192/108; 192/46

(57) ABSTRACT

The invention relates to a free-wheeling cage having a basic body, wherein the basic body includes a first cage ring and a second cage ring, which are arranged around a common axis and wherein cage webs extend axially between the two cage rings, whereby cage pockets are formed, wherein the basic body includes a lubricant reservoir which allows a metered dispensing of lubricant.

### CROSS-REFERENCE TO RELATED APPLICATIONS

This patent claims priority from German Patent Application No. 10 2012 208 057.0, filed May 14, 2012, which application is incorporated herein by reference in its entirety.

### FIELD OF THE INVENTION

The invention broadly relates to a free-wheeling cage, for example for use in clamping roller freewheels or clamping body freewheels.

### BACKGROUND OF THE INVENTION

A free-wheeling cage including a basic body is disclosed in DE 10 2008 037 972 A1. The basic body has two cage rings, where cage webs extend axially between the cage rings. The cage rings and the cage webs create cage pockets. The cage pockets serve as retainers for clamping bodies or clamping rollers. Spring-loaded elements are braced against the cage webs, the spring-loaded elements serving as spring bias of the clamping bodies or clamping rollers.

In addition, a ring-shaped component is provided in DE 10 2008 037 A1 for fastening the free-wheeling cage in an outer or inner ring. The ring-shaped component is attached on the front of a cage ring.

A free-wheeling cage formed as a single piece with an inner ring is disclosed in DE 10 2008 049 799 A1. Cage rings are integrally shaped onto both sides of the inner ring. In addition, cage webs are integrally shaped onto one of the cage rings, the cage webs being arranged distributed around the entire circumference of the inner ring.

### BRIEF SUMMARY OF THE INVENTION

The present invention broadly includes a free-wheeling cage which extends the service life of a free-wheel. Based on the invention, this object is solved with a free-wheeling cage having a basic body, where the basic body includes a first cage ring and a second cage ring which are arranged around a common axis and where cage webs extend axially between the two cage rings, thus forming cage pockets, where the basic body includes a lubricant reservoir which allows a metered dispensing of lubricant.

Free-wheeling cages are used in different types of free-wheels. The free-wheeling cage itself serves as a retainer of clamping bodies/clamping rollers and spring-loaded elements. Free-wheeling cages are usually arranged between a driving part and a driven part. Moreover, a lubricant is usually placed between the individual components to help reduce the wear of the individual components. However, the lubricant accumulates in “low-motion” areas of the free-wheel during the usable life.

The free-wheeling cage of the invention provides a lubricant reservoir for the supply of a free-wheel. The lubricant reservoir continuously supplies the free-wheel with lubricant during the entire usable life. Fats, oils or other lubricants can be used as lubricants. On the one hand, the service life of a free-wheel can be extended because a lubricant supply can be secured for the entire usable life of the free-wheel with the lubricant reservoir. On the other hand, component wear and corrosion due to the lack of lubricant can be avoided.

In a further embodiment, the lubricant reservoir is formed by means of a container and arranged in one of the cage pockets. Advantageously, not only one container is provided, but a plurality of containers are arranged distributed across the entire circumference. The container predominantly is a closed space, which can be designed for example with side walls, a top part and a bottom part. In so doing, the container can be case-shaped, box-shaped or designed in any other shape and be made of plastic or metalline material. The lubricant is poured into the container and stored there. The container can dispense the lubricant during the useful life of the free-wheel. The arrangement or integration of the container in a cage pocket allows the compact manufacture of a free-wheel, whereby enlargements of the installation space can be avoided.

In a further embodiment, the container has a radial opening used for the metered dispensing of lubricant. Alternatively, a plurality of openings can be provided. The lubricant stored in the container can be dispensed by means of the opening. The opening is arranged in the container such that the container is radially open toward the inside and/or toward the outside. The lubricant amount is determined by the shape and size of the opening in the container. This means, the smaller the opening, the larger the quantity of dispensed lubricant is. On the one hand, the shape and size of the opening depend on the size of the container and the free-wheeling cage and on the other hand on the application. The opening can be hole-like, hole-related, round, elliptical, rectangular, T-shaped or have any other shape.

In another example embodiment of the invention, the container is designed as a separate component and the shape and size of the container coincide with the shape and size of a cage pocket. This is necessary to be able to place the container in one of the cage pockets. Advantageously, the container has a rectangular shape which coincides with the cage pocket. In an example embodiment of the invention, the container can be attached in one of the cage pockets by means of form closure. For this purpose, projecting lugs can be provided on the container, the lugs engaging in recesses of the cage rings and/or cage webs. Other form-fitting connections are possible as well. Alternatively, the container can be attached in one of the cage pockets by means of a frictional connection or material contact.

In a further embodiment of the invention, the container is designed as one piece with the basic body. In so doing, it is possible to integrate the entire container in the basic body, i.e., such that a cage pocket is designed as a closed space. In this case, the cage webs and cage rings form side walls of the container. Moreover, the cage pockets are radially closed with a bottom part and a top part. The top part and bottom part can be designed as one piece on the basic body. It is also possible that only the top part or the bottom part is designed as one piece on the basic body.

For example, cage ring includes a recess in the region of the container, where the recess can be positively locked by means of a ring. Particularly for a container designed as one piece with the basic body, the arrangement serves the purpose of pouring the lubricant into the container. The recess provided in one of the cage rings is used for the filling. The shape of the recess can have any shape. To prevent the lubricant from escaping through the recess, the container is closed by means of a ring. The ring has the shape and size of a cage ring. This allows a simple and economic manufacture. The ring can be connected with the container or with the basic body by means of form closure, frictional connection or material contact.

The free-wheeling cage can preferably be provided in a free-wheel. The free-wheeling cage is arranged between a driving part and a driven part, where clamping bodies are provided in the cage pockets, where spring-loaded elements are provided for the spring bias of the clamping bodies. The driving part and the driven part form sliding surfaces for the clamping bodies. The lubricant reservoir provided in the free-wheeling cage serves the continuous supply of the individual free-wheel components with lubricant.

The clamping bodies are preferably designed as clamping rollers. Alternatively, clamping needles are also possible.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a free-wheeling cage of the invention corresponding to a first embodiment; and,

FIG. 2 is a perspective view of a free-wheeling cage of the invention corresponding to a second embodiment.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

Identical elements are provided with the same reference numerals in the figures and are described only once.

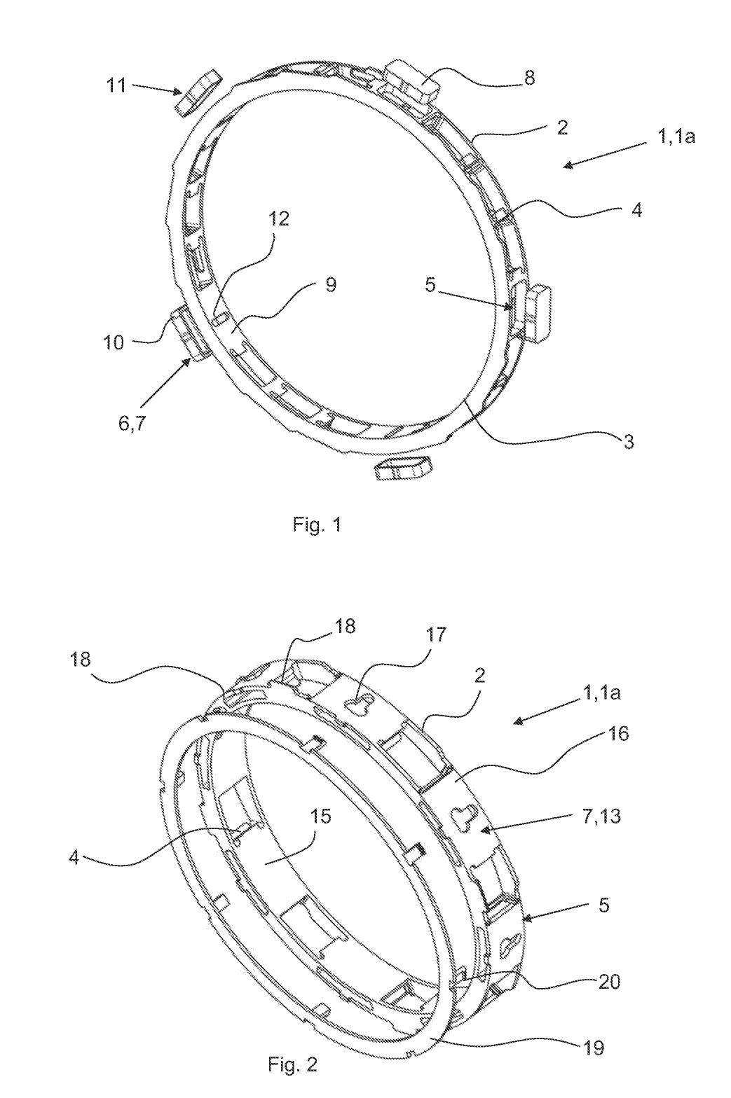

Adverting now to the figures, FIG. 1 shows free-wheeling cage 1 of the invention corresponding to an example embodiment. Free-wheeling cage 1 includes basic body 1a. Basic body 1a includes cage rings 2 and 3. Cage webs 4 extend between cage rings 2 and 3, which together form cage pockets 5. Cage pockets 5 serve as retainers of not illustrated clamping bodies as well as a number of not illustrated spring-loaded elements, the number corresponding to the number of clamping bodies.

Basic body 1a includes lubricant reservoir 6. Lubricant reservoir 6 is formed with container 7, which is arranged in one of cage pockets 5. This means that instead of clamping bodies and spring-loaded elements, container 7 is provided in cage pocket 5. Container 7 is used to hold lubricant. As illustrated in FIG. 1, a total of five containers 7 each in cage pocket 5 are provided. The remaining cage pockets are used to retain clamping bodies and spring-loaded elements.

Container 7 has top part 8, bottom part 9, and four side walls 10. Bottom part 9 is designed as one piece on basic body 1a. Side walls 10 and top part 8 are designed as a separate part and form cap-like structure 11. Cap 11 is attached in cage pocket 5, which includes bottom part 9 by means of form closure.

Opening 12 is provided in bottom part 9. Opening 12 is designed as an elongated hole. Opening 12 runs parallel to cage webs 4 and is arranged close to the center in bottom part 9. Opening 12 is used for the continuous and metered dispensing of lubricant from container 7.

FIG. 2 shows free-wheeling cage 1 of the invention corresponding to an example embodiment. To simplify the description, parts corresponding to each other are labeled with the same reference numbers as in the previous FIG. 1.

As illustrated in FIG. 2, container 13 of lubricant reservoir 6 is designed as one piece with basic body 1a. This means that side walls 14 of container 13 are formed with cage webs 4 and two cage rings 2 and 3. Moreover, bottom part 15 and top part 16 are designed as one piece on the basic body and as a result, a predominantly closed space is available for the lubricant. Opening 17 is provided in top part 16 for the metered dispensing of lubricant from container 7. Opening 17 is T-shaped and arranged close to the center in top part 16.

Moreover, FIG. 2 reveals that cage ring 3 has recess 18 in the region of container 7. Recess 18 extends in the region of container 7 between two cage webs 4. Recess 18 is used to fill container 7 with lubricant.

Ring 19 is provided close to recess 18. The shape and size of ring 19 coincides with the shape and size of cage rings 2 and 3. For the closure, ring 19 is connected with basic body 1a by means of form closure. Projecting lugs 20 are provided at the ring for this purpose. For fastening, lugs 20 engage with matching counter elements which are provided in basic body 1a or container 7. Here, opening 17 is simultaneously used for fastening ring 19. For this purpose, lugs 20 are pushed into container 7 through recess 18 and “hook” onto opening 17.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### LIST OF REFERENCE NUMERALS

1 Free-wheeling cage
1a Basic body
2 Cage ring
3 Cage ring
4 Cage web
5 Cage pockets
6 Lubricant reservoir
7 Container
8 Top part
9 Bottom part
10 Side walls
11 Cap
12 Opening
13 Container
14 Side walls
15 Bottom part
16 Top part
17 Opening
18 Recess
19 Ring
20 Lugs

What is claimed is:

1. An apparatus for a free-wheeling cage, comprising:
a basic body, wherein the basic body comprises a first cage ring and a second cage ring, which are arranged around a common axis and wherein cage webs extend between the two cage rings, whereby cage pockets are formed, wherein the basic body comprises a lubricant reservoir which allows a metered dispensing of lubricant.

2. The free-wheeling cage as recited in claim 1, wherein the lubricant reservoir is formed by means of a container, wherein the one container is arranged in one of the cage pockets.

3. The free-wheeling cage as recited in claim 2, wherein the container is designed as a separate component and wherein the shape and size of the container coincides with the shape and size of a cage pocket.

4. The free-wheeling cage as recited in claim 3, wherein the container is attached in one of the cage pockets by means of form closure.

5. The free-wheeling cage as recited in claim 2, wherein the container is formed as one piece with the basic body.

6. The free-wheeling cage as recited in claim 5, wherein a cage ring comprises a recess in the region of the container and wherein the recess is positively locked by means of a ring.

7. The free-wheeling cage as recited in claim 1, wherein the container comprises a radial opening, which is used for the metered dispensing of lubricant.

8. The free-wheeling cage as recited in claim 1, wherein a free-wheeling cage is arranged between a driving part and a driven part and wherein clamping bodies are provided in the cage pockets, wherein spring-loaded elements are provided for the spring bias of the clamping bodies.

9. The free-wheeling cage as recited in claim 8, wherein the clamping bodies are designed as clamping rollers.
